(19) United States
(12) Patent Application Publication
(10) Pub. No.: US 2007/0039051 A1
(43) Pub. Date: Feb. 15, 2007

(54) Apparatus And Method For Acceleration of Security Applications Through Pre-Filtering

(75) Inventors: Peter Duthie, Sydney (AU); Peter Bisroev, Coogee South (AU); Teewoon Tan, Roseville (AU); Darren Williams, Newtown (AU); Robert Matthew Barrie, Double Bay (AU); Stephen Gould, Killara (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., Palo Alto, CA (US)

(21) Appl. No.: 11/465,634

(22) Filed: Aug. 18, 2006

Related U.S. Application Data
(63) Continuation-in-part of application No. 11/291,524, filed on Nov. 30, 2005.
(60) Provisional application No. 60/632,240, filed on Nov. 30, 2004.

(51) Int. Cl. G06F 12/14; G06F 11/00; H04L 9/32; G06F 11/30; G06F 12/16; G06F 15/18; G08B 23/00

(52) U.S. Cl. 726/22; 726/23; 726/24; 726/25; 713/188

(57) ABSTRACT

A first security processing stage performs a first multitude of tasks and a second security processing stage performs a second multitude of tasks. The first and second multitude of tasks may include common tasks. The first security processing stage is a prefilter to the second security processing stage. The input data received as a data stream is first processed by the first security processing stage, which in response, generates one or more first processed data streams. The first processed data streams may be further processed by the second security processing stage or may bypass the second security processing stage. The first security processing stage operates at a speed greater than the speed of the second security processing stage.

### CROSS-REFERENCES TO RELATED APPLICATIONS

The present invention is a continuation-in-part of U.S. application Ser. No. 11/291,524, filed Nov. 30, 2005, entitled Apparatus and Method for Acceleration of Security Applications Through Pre-Filtering, and claims benefit under 35 USC 119(e) of U.S. provisional Application No. 60/632,240, filed Nov. 30, 2004, entitled “Apparatus and Method for Acceleration of Security Applications Through Pre-Filtering”, the content of which is incorporated herein by reference in its entirety.

The present application is also related to copending application Ser. No. 11/291,512, filed Nov. 30, 2005, entitled “Apparatus And Method For Acceleration Of Electronic Message Processing Through Pre-Filtering;” copending application Ser. No. 11/291,511, filed Nov. 30, 2005, entitled “Apparatus And Method For Acceleration Of Malware Security Applications Through Pre-Filtering;” copending application Ser. No. 11/291,530, filed Nov. 30, 2005, entitled “Apparatus And Method For Accelerating Intrusion Detection And Prevention Systems Using Pre-Filtering;” all assigned to the same assignee, and all incorporated herein by reference in their entirety.

### BACKGROUND OF THE INVENTION

Electronic messaging, such as email, Instant Messaging and Internet Relay Chatting, and information retrieval, such as World Wide Web surfing and Rich Site Summary streaming, have become essential uses of communication networks today for conducting both business and personal affairs. The proliferation of the Internet as a global communications medium has resulted in electronic messaging becoming a convenient form of communication and has also resulted in online information databases becoming a convenient means of distributing information. Rapidly increasing user demand for such network services has led to rapidly increasing levels of data traffic and consequently a rapid expansion of network infrastructure to process this data traffic.

The fast rate of Internet growth, together with the high level of complexity required to implement the Internet's diverse range of communication protocols, has contributed to a rise in the vulnerability of connected systems to attack by malicious systems. Successful attacks exploit system vulnerabilities and, in doing so, exploit legitimate users of the network. For example, a security flaw within a web browser may allow a malicious attacker to gain access to personal files on a computer system by constructing a webpage specially designed to exploit the security flaw when accessed by that specific web browser. Likewise, security flaws in email client software and email routing systems can be exploited by constructing email messages specially designed to exploit the security flaw. Following the discovery of a security flaw, it is critically important to block malicious traffic as soon as possible such that the damage is minimized.

Differentiating between malicious and non-malicious traffic is often difficult. Indeed, a system connected to a network may be unaware that a successful attack has even taken place. Worms and viruses replicate and spread themselves to vast numbers of connected systems by silently leveraging the transport mechanisms installed on the infected connected system, often without user knowledge or intervention. For example, a worm may be designed to exploit a security flaw on a given type of system and infect these systems with a virus. This virus may use an email client pre-installed on infected systems to autonomously distribute unsolicited email messages, including a copy of the virus as an attachment, to all the contacts within the client's address book.

Minimizing the amount of unsolicited electronic messages, or spam, is another content security related problem. Usually as a means for mass advertising, the sending of spam leverages the minimal cost of transmitting electronic messages over a network, such as the Internet. Unchecked, spam can quickly flood a user's electronic inbox, degrading the effectiveness of electronic messaging as a communications medium. In addition, spam also may contain virus infected or spy-ware attachments.

Electronic messages and World Wide Web pages are usually constructed from a number of different components, where each component can be further composed of subcomponents, and so on. This feature allows, for example, a document to be attached to an email message, or an image to be contained within a webpage. The proliferation of network and desktop applications has resulted in a multitude of data encoding standards for both data transmission and data storage. For example, binary attachments to email messages can be encoded in Base64, Uuencode, Quoted-Printable, BinHex, or a number of other standards. Email clients and web browsers must be able to decompose the incoming data and interpret the data format in order to correctly render the content.

To combat the rise in security exploits, a number of network service providers and network security companies provide products and applications to detect malicious web content, malicious email and instant messages, and spam email. Referred to as content security applications, these products typically scan through the incoming web or electronic message data looking for rules which indicate malicious content. Scanning network data can be a computationally expensive process involving decomposition of the data and rule matching against each component. Statistical classification algorithms and heuristics can also be applied to the results of the rule matching process. For example, an incoming email message being scanned by such a system could be decomposed into header, message body and various attachments. Each attachment may then be further decoded and decomposed into subsequent components. Each individual component is then scanned for a set of predefined rules. Spam emails include patterns such as “click here” or “make money fast”.

FIG. 1 shows a data proxy, such as an HTTP proxy used for scanning and caching World Wide Web content, as known to those skilled in the art. The diagram shows an external packet-based network 120, such as the Internet, and a server 110. A data proxy 130 is disposed between the external packet-based network 120 and the local area network 140. Data coming from the external packet based network 120 passes through the data proxy 130. A multitude of client machines 150, 160, 170 are connected to the local area network.

The data flow for a typical prior art network content security application is shown in FIG. 6A. Data is received off the network in step 610 and usually reassembled into data streams. These data streams are routed to the content security application which analyses the data by decomposing the data into constituent parts and scanning each part in step 620. Some content security applications have built in virtual machines for emulating executable computer code. Data which is deemed to have malicious content is either quarantined, deleted, or fixed by removing the offending components in step 640. Legitimate non-malicious data and fixed content is forwarded on to the local area network in step 630.

Merely by way of example, a user on client machine 150 on the local area network 140 issues a request to the server 110 on the external packet based network 120 (see FIG. 1). The user's request passes through the proxy 130 which forwards the request to server 110. In response to the user's request, the server 110 delivers content to the proxy 130. The content security application 135 running on the server checks the content before final delivery to the user in an attempt to remove or sanitize malicious content before it reaches the user on client machine 150.

Since each user on the local area network can make a large number of simultaneous requests for data from the external packet-based network 120 through the data proxy 130, and there is a multitude of user machines on the local area network 140, a large amount of data needs to be processed by the data proxy 130. Those skilled in the art recognize that the data proxy 130 running the content security application 135 becomes a performance bottleneck in the network if it is unable to process the entirety of the traffic passing through it in real-time. Furthermore the content security application 135 is complex and therefore cannot be easily accelerated.

Content security applications are becoming over-burdened with the volume of data as network traffic increases. Security engines need to operate faster to deal with ever increasing network speeds, network complexity, and growing taxonomy of threats. However, content security applications have evolved over time and become complex interconnected subsystems. These applications are rapidly becoming the bottleneck in the communication systems in which they are deployed to protect. In some cases, to avoid the bottleneck, network security administrators are turning off key application functionality, defeating the effectiveness of the security application. The need continues to exist for a system with an accelerated performance for use in securing communication networks.

### BRIEF SUMMARY OF THE INVENTION

The present invention provides systems and methods for improving the performance of content security applications and networked appliances. In one embodiment, the invention includes, in part, first and second security processing stages. The first processing stage is operative to process received data streams and generate first processed data stream(s). The second processing stage is configured to generate second processed data stream(s) from the first processed data stream(s). The operational speed of the first security processing stage is greater than the operational speed of subsequent stages, e.g. second stage. The first security processing stage is configured to send the first processed data stream(s) to any of the subsequent security processing stages, when there are more than two processing stages. The first security stage may alternatively send the first processed data stream(s) as first output data streams, and bypass at least one of the subsequent security processing stages.

In an embodiment, the first and second security processing stages are adapted to perform at least one of the following functions: anti virus filtering, anti spam filtering, anti spyware filtering, content processing, network intrusion detection, and network intrusion prevention. In other embodiments, the first and second security processing stages may perform one or more common tasks, some of which tasks may be performed concurrently.

In an embodiment, the first processing stage is further configured to include one or more hardware modules. In one embodiment, the first processed data stream(s) are associated with one or more classes of network data each having a different format and each being different from the format of the received data stream. In another embodiment, the first processed data stream(s) are associated with one or more classes of network data each having a common format different from the format of the received data stream. In an embodiment, each of the first processed data stream(s) is directed to a different destination.

In an embodiment, the second processed data stream(s) are associated with one or more classes of network data each having a different format and each being different from the format of the received data stream. In another embodiment, the second processed data stream(s) are associated with one or more classes of network data each having a common format different from the format of the received data stream. In an embodiment, each of the second processed data stream(s) is directed to a different destination.

### BRIEF DESCRIPTION OF THE DRAWINGS

FIG. 1 depicts a content security system, as known in the prior art.

FIG. 2 depicts a content security system, in accordance with an embodiment of the present invention.

FIG. 3A shows logical blocks of a content security system, in accordance with an embodiment of the present invention.

FIG. 3B shows logical blocks of a content security system, in accordance with another embodiment of the present invention.

FIG. 3C shows logical blocks of a content security system, in accordance with another embodiment of the present invention.

FIG. 4 shows a Receiver Operating Characteristics (ROC) curve,.

FIG. 5 shows two different ROC curves of differing quality, as known in the prior art.

FIG. 6A shows the flow of data in a content security system, as known in the prior art.

FIG. 6B shows the flow of data in a content security system, in accordance with an embodiment of the present invention.

FIG. 7 is a logic block diagram of the data proxy apparatus of FIG. 2, in accordance with one embodiment of the present invention.

### DETAILED DESCRIPTION OF THE INVENTION

According to the present invention, techniques for improving the performance of computer and network security applications are provided. More specifically, the invention provides for methods and apparatus to accelerate the performance of content security applications and networked devices. Merely by way of example, content security applications include anti virus filtering, anti spam filtering, anti spyware filtering, XML-based, VoIP filtering, and web services applications. Merely by way of example, networked devices include gateway anti virus, intrusion detection, intrusion prevention and email filtering appliances.

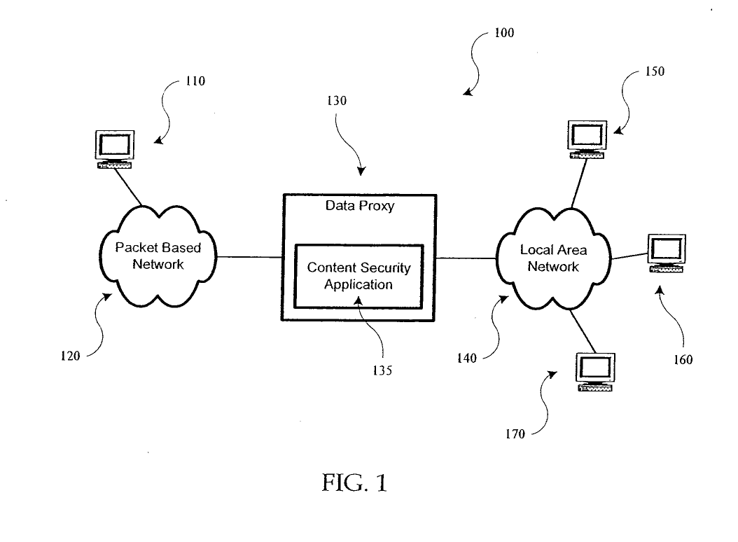

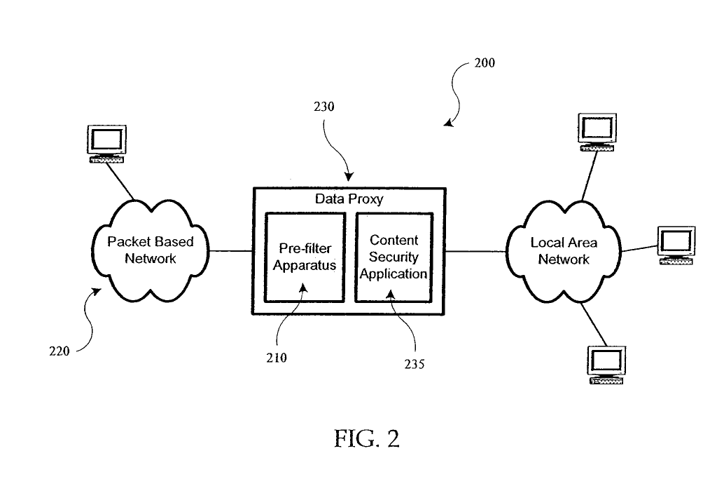

In accordance with an embodiment of the present invention, an apparatus 210 is configured to perform pre-filtering on the requested data streams from the external packet based network 220, as shown in FIG. 2. Apparatus 210 is configured to inspect the data streams faster than conventional content security applications, such as that identified with reference numeral 135 in FIG. 1. Data proxy 230 which includes, in part, pre-filter apparatus 210 and content security application 235 processes data at a faster rate than conventional data proxy 130 (shown in FIG. 1) that includes only content security application 135. In some embodiments specialized hardware acceleration is used to increase the throughput of pre-filter apparatus 210.

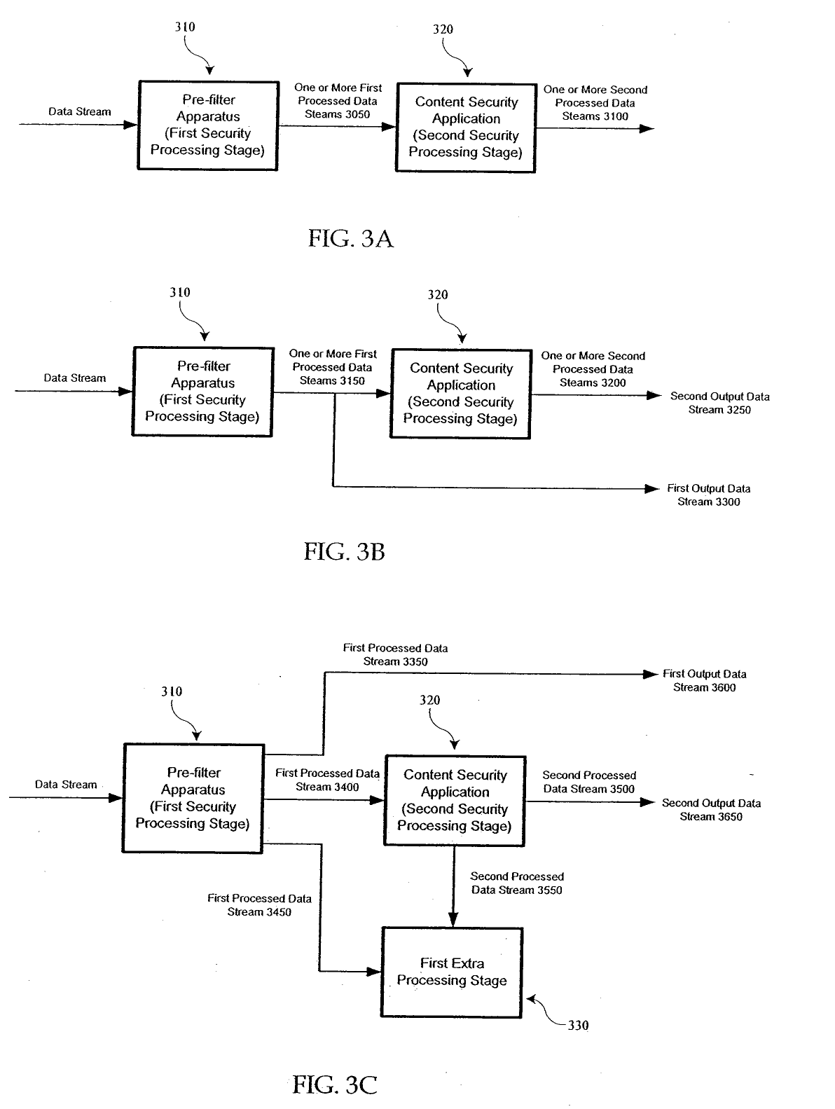

FIG. 3A is a simplified high level block diagram of the data flow between a pre-filter apparatus 310 and a content security application 320. This diagram is merely an example, which should not unduly limit the scope of the claims herein. One of ordinary skill in the art would recognize other variations, modifications, and alternatives. The pre-filter apparatus 310 is alternatively referred to as the first security processing stage 310, and the content security application 320 is alternatively referred to as the second security processing stage 320. In the embodiment shown in FIG. 3A, the first security processing stage 310 receives a data stream in a first format, processes the data stream by performing a first multitude of tasks and generates one or more first processed data streams 3050 in a second format. The first security processing stage 310 performs the first multitude of tasks at a first processing speed. In an embodiment, the data stream includes e-mail messages formatted in a standard and typical representation, which includes standard representations such as the RFC 2822 format for e-mail headers. In another embodiment, the first multitude of tasks performed by the first security processing stage 310, acting as a pre-filter apparatus, includes pattern matching operations performed on e-mail messages received as the input data stream.

In an embodiment of the present invention, the pattern matching operations performed by the pre-filter apparatus are directed at detecting viruses in the received e-mail messages. The result of performing these pattern matching operations is a classification of the maliciousness of the received e-mail message, where the classification result can be one of malicious, non-malicious, or possibly-malicious. This classification result, as well as the received e-mail messages, is included in the one or more first processed data streams 3050 output by the first security processing stage 310.

The one or more first processed data streams 3050 transmitted by the first security processing stage 310 are received by the second security processing stage 320. The second security processing stage 320 processes the received one or more first processed data streams 3050 by performing a second multitude of tasks to generate one or more second processed data streams 3100 in a third format. The second security processing stage 320 performs the second multitude of tasks at a second processing speed, where the first processing speed is greater than the second processing speed. In an embodiment of the invention, the second security processing stage 320 performs the functions of an anti virus filter. The results of the filtering process are included in the one or more second processed data streams 3100. In such embodiments, the first and second multitude of tasks share the common task of detecting viruses in received e-mail messages using pattern matching operations. Also in such embodiments, the first and second multitude of tasks is configured to be performed concurrently.

FIG. 3B is a simplified high level block diagram that illustrates the one or more first processed data streams 3150 being further redirected and output as one or more first output data streams 3300. The one or more second processed data streams 3200 are output as one or more second output data streams 3250.

In an embodiment, the one or more first and second output data streams are transmitted to other processing modules. A simplified high level block diagram of such an embodiment is illustrated in of FIG. 3C, where three first processed data streams, 3350, 3400 and 3450, are generated by the first security processing stage 310 and two second processed data streams, 3500 and 3550, are generated by the second security processing stage 320. The first processed data stream 3400 is transmitted by the first security processing stage 310 to the second security processing 320 for further processing. The first processed data stream 3450 is transmitted by the first security processing stage 310 to a first extra processing stage 330. Similarly, the second security processing stage 320 transmits the second processed data stream 3550 to the first extra processing stage 330 for further processing. The first processed data stream 3350 generated by the first security processing stage 310 is output as a first output data stream 3600, and the second security processing stage 320 generates and outputs a second processed data stream 3500 as a second output data stream 3650. The first extra processing stage 330 is configured to receive and process the first processed data stream 3450 and the second processed data stream 3550.

In an embodiment of the invention, the first security processing stage 310, being configured to operate as an anti virus pre-filtering apparatus, processes the input data stream and generates a classification for the data stream. If the classification result is “malicious”, then the classification result and the received e-mail message is transmitted to the first extra processing stage 330, where the first extra processing stage 330 in such an embodiment is configured to quarantine the virus-infected e-mail message in a storage device.

If the classification result is “non-malicious”, then the received e-mail message is included in the generated first processed data stream 3350 and sent to a user's mail box. The first processed data stream 3350 is output as a first output data stream 3600, where a user's mail box is coupled to the first security processing stage 310 and adapted to receive e-mail messages included in the first output data stream 3600.

If the classification result is “possibly-malicious”, then the received e-mail message and the classification result is included in the generated first processed data stream 3400 and sent to the second security processing stage 320 for further processing. In this first embodiment of the invention, the second security processing stage 320 is configured to classify the e-mail message included in the first processed data stream 3400 as containing “malicious”, or “non-malicious” data. If the second security processing stage 320 classification result is “malicious”, then the e-mail message is included in the second processed data stream 3550 and transmitted to the first extra processing stage 330, where the first extra processing stage 330 is configured to quarantine the virus-infected e-mail message in a storage device. If the second security processing stage 320 classification result is “non-malicious”, then the e-mail message is included in the generated second processed data stream 3500 and sent to a user's mail box. The second processed data stream 3500 is output as a second output data stream 3650, where a user's mail box is coupled to the second security processing stage 320 and adapted to receive e-mail messages included in the second output data stream 3650. In an embodiment, the first output data stream 3600 and second output data stream 3650 are connected to the same port of a mail box handling module that handles the receipt and delivery of e-mail messages to users.

Merely by way of example, the first security processing stage 310 and second security processing stage 320 may be configured to perform one or more of the following tasks: intrusion detection, intrusion prevention, anti virus filtering, anti spam filtering, anti spyware filtering, and content processing and filtering. In an embodiment, the first and second processed data streams include data derived by tasks adapted to perform: intrusion detection, intrusion prevention, anti virus filtering, anti spam filtering, anti spyware filtering, and content processing and filtering. The data included in the first processed data stream can be different for each different task and also different from the first format. The data included in the second processed data stream can be different for each different task and also different from the first format.

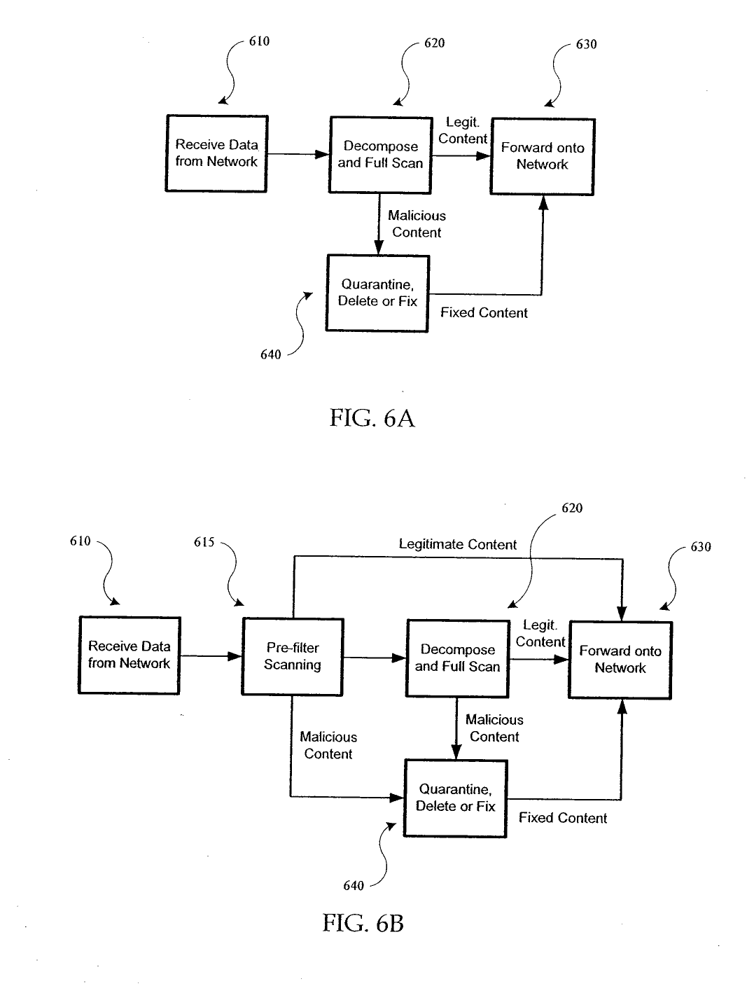

In accordance with the present invention, a pre-filter is placed in the data path before the content security application performs decomposition and scanning operations as shown in FIG. 6B. Data is received off the network in step 610 and usually reassembled into data streams. These data streams are routed to the pre-filter which scans the data in step 615. If the pre-filter scanning in step 615 detects malicious content, it can be passed directly to be quarantined, deleted or fixed in step 640, and not further decomposed or scanned. Likewise if the pre-filter determines that the data is not malicious, then it can be forwarded directly onto the local area network in step 630. If the pre-filter cannot determine whether the data is malicious or not, the data is passed to the content security application for decomposition and full scanning in step 620.

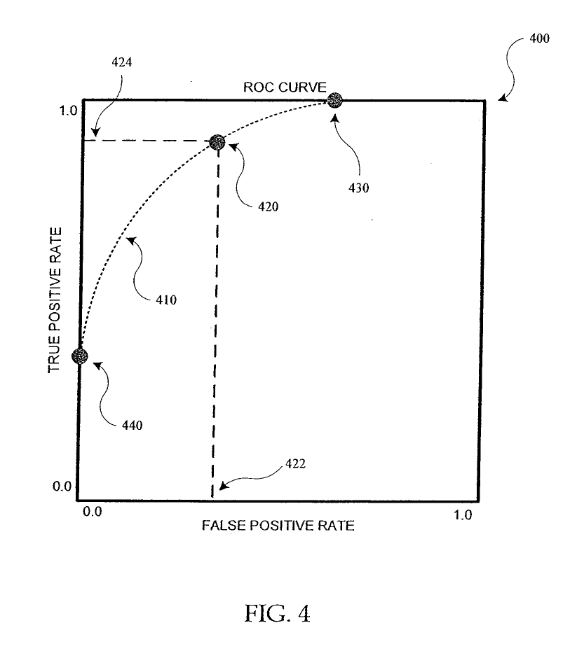

Content security applications are required to classify the content of the incoming data stream as accurately as possible such that the incidence of false-positives and false-negatives is minimized. A false-positive, as known to those skilled in the art, incorrectly identifies legitimate non-malicious data as being malicious. In this case, the content security application blocks user access to legitimate data. Similarly, a false-negative incorrectly identifies malicious data as being legitimate non-malicious data. In this case, malicious data would be passed through to the end user, resulting in a security breach. FIG. 4 is a graph of the true-positive rate against false-positive rate. The collection of values plotted on the graph is known to those skilled in the art as a Receiver Operator Characteristics (ROC) curve. ROC curves show the quality of a classification algorithm. The curve 410 starts at the bottom-left corner of the graph and moves continuously to the top-right corner. The bottom-left corner indicates no false-positives. However it also corresponds to no true-positives. This operating point can be achieved simply by building a classifier that always returns “NEGATIVE” as understood by those skilled in the art. Similarly, the top-right corner corresponds to both a 100% false-positive rate and a 100% true-positive rate. As understood by those skilled in the art, this can be achieved by constructing a classifier which always returns “POSITIVE”. The classifier can be tuned by trading off false-positive rate against true-positive rate to any point on the ROC curve 410. The closer the curve is to the upper-left corner, the better the quality of the classifier.

Content security applications can make use of the ROC curve to trade-off accuracy of detecting malicious content against denial of legitimate content. By way of example, the point 420 on the ROC curve has a false-positive rate corresponding to the value at 422 and true-positive rate corresponding to the value at 424. Another point 430 on the ROC curve achieves a 100% true-positive rate, but also has a higher false-positive rate. If a content security application were to operate at the point 430, all malicious data would be detected at the expense of also blocking a large amount of legitimate traffic.

In order to improve the accuracy of their content security applications, content security vendors aim to simultaneously reduce false-positive rate whilst maintaining 100% true-positive rate. This corresponds to detecting all malicious data (“POSITIVE”) and allowing through almost all non-malicious content (“NEGATIVE”). Reducing the false-positive rate is computationally expensive such that hardware and software constraints limit the feasible maximum accuracy of the content security application.

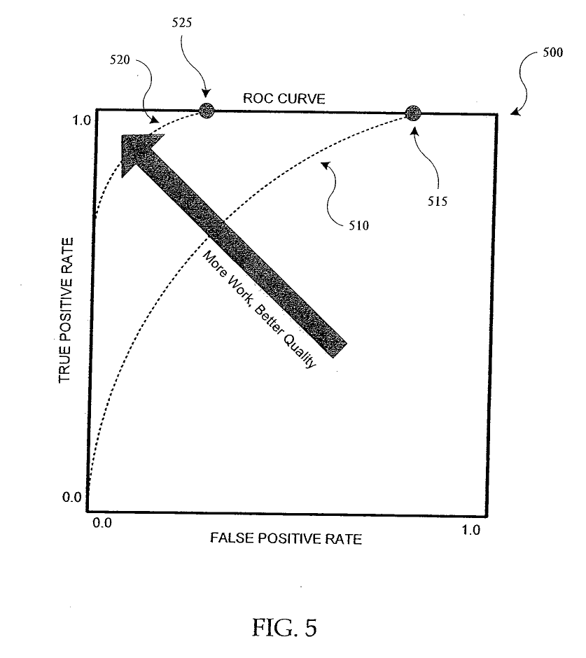

In accordance with an embodiment of the present invention, a pre-filter is used before the content security application and is configured to operate much faster than the content security application. In an embodiment, the pre-filter has an operating point illustrated in FIG. 5 by point 515 on ROC curve 510. It is understood that this ROC curve is merely illustrative and that various other embodiments of the invention can have different operating characteristics. By setting the pre-filter to operate at the point indicated by, for example, point 515, the pre-filter is able to detect all malicious content, and in addition, is able to classify some legitimate content correctly due to the false-positive rate being less than 100%.

At this operating point 515, in an embodiment, the data determined by the pre-filter not to be malicious (i.e. “NEGATIVE”) is passed to the user without further scanning by the content security application. Data which is determined by the pre-filter to be possibly malicious is passed to the content security application for further analysis and scanning. Since the pre-filter has the ability to send data it classifies as non-malicious directly to the user without going through the content security application, the volume of traffic needed to be processed by the content security application is reduced. The amount of traffic sent to the content security application is reduced by the following percentage:
bypass_rate=(1−false_positive_rate)×(% non_malicious_data),
where bypass_rate is the percentage of data that is passed directly to the user, thus the data bypasses the content security application.

Merely by way of example, if the pre-filter processes data at a bytes per second, and the content security application processes data at b bytes per second, then the overall average system processing rate over a given period is defined by:
system_processing_rate=1/((1/a)+((1/b)×(100%−bypass_rate))).
Where system_processing_rate is the rate at which the system processes the data.

If the pre-filter operates at speeds that are significantly faster than the content security application, then the overall average system processing rate is approximately given by:
system_processing rate≈1/((1/b)×(100%−bypass_rate)).

Therefore, the system processing rate increases as bypass_rate increases. The bypass_rate is determined by the operating characteristics of the pre-filter. In an embodiment, the pre-filter processes the input data stream using a set of rules derived from a set of rules used in the content security application. Typically, the rule derivation process ensures that an appropriate set of rules is used in the pre-filter, so that the pre-filter operates with a high bypass rate whilst ensuring that the malicious data classification accuracy rate of the overall system is comparable or better than that of conventional systems.

In the above example, operating point 515 on ROC curve 510 as shown in FIG. 5 was chosen because it exhibits the property that it achieves 100% true-positive rate. It is understood that in other embodiments of the present invention other operating points on the ROC curve may be chosen and that the present invention is operable at any true-positive rate. For example, the false-negative rate can be set to 0%, such as illustrated in FIG. 4 by point 440 on ROC curve 410. In this example, all data detected as “POSITIVE” will be immediately subjected to the security policy (i.e. quarantined or dropped), while all data classified as “NEGATIVE” would be subjected to further analysis by the content security application. The amount of traffic sent to the content security application is reduced by the following percentage:
bypass_rate=(true_positive_rate)×(% malicious_data).

The overall system processing rate can then be determined using the same methods described above, where the rate is given by:
system_processing_rate=1/((1/a)+((1/b)×(100%−bypass_rate))),

If the pre-filter processing speed is significantly faster than that of the content security application, then the system processing rate can be approximated by:
system_processing_rate ≈1/((1/b)×(100%−bypass_rate)),

In some embodiments of the present invention, the pre-filter applies a pattern matching operation on the data stream without requiring to first decompose or decode the data. The incoming data stream is matched against a rule database. If any of the patterns in the rule database are detected as matching, then the data stream is transferred to the content security application for further analysis. Otherwise the data is allowed to pass through to the user. The patterns in the rule database can be literal strings or regular expressions.

In other embodiments of the present invention, the incoming data stream is matched against two rule databases. If any of the patterns in the first rule database are detected as matching and none of the patterns in the second rule database are detected as matching, then the data stream is transferred to the content security application for further analysis. If any of the rules in the second database are detected as matching the incoming data stream, then the data content is considered as malicious and action taken in accordance with the system's security policies. If none of the patterns from the first rule database are detected as matching and none of the patterns from the second rule database are detected as matching, then the data is passed through to the user.

In another embodiment, the first security processing stage 310 shown in FIG. 3 is further configured to classify the input data stream into other classification types, such as “spam” or “spyware-infected”. Based on the classification types, the first security processing stage 310 may then selectively transmit some of the one or more first processed data streams such that the content security application is bypassed. In yet another embodiment of the present invention, the first and second databases are assigned a first weight and a second weight, the first weight being assigned to the first database and the second weight being assigned to the second database. Whether the data should be further scanned or not, is determined by combining the weighted sum from each of the databases and comparing to one or more predefined thresholds. In still further embodiments of the invention, hardware acceleration is used to accelerate inspection of the data by the pre-filter.

In one embodiment, the present invention is adapted to perform security processing of email, and in particular the acceleration of security services for detection and quarantining of viruses, spam (unsolicited bulk email), or spyware (herein referred to as “malicious content”) in email messages through the combination of software and hardware processing.

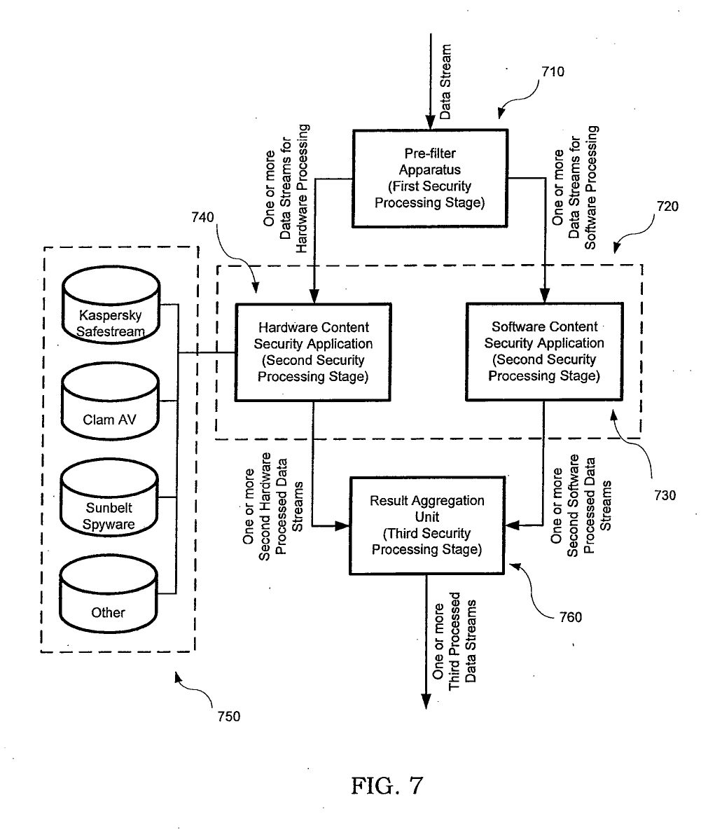

FIG. 7 shows an embodiment of the data proxy apparatus 230 (shown in FIG. 2). In this embodiment, electronic mail messages enter the first security processing stage 710 from one or more network or storage interfaces. Each mail message is inspected by the first security processing stage, which determines, from meta-data describing the data format and type, which second security processing stage application, software 730 or hardware 740, is best suited for scanning the message for malicious content. In some embodiments the first security processing stage also takes into account throughput and traffic load on both the hardware and software.

In one embodiment the incoming data stream is split into one or more components by the first security processing stage 710 and each component is scanned. The one or more components are divided into a first sequence of components and a second sequence of components. The first sequence of components includes one or more data streams for hardware processing, and the second sequence of components includes one or more data streams for software processing. The first sequence of components is processed by the hardware content security application 740 in the second security processing stage to generate one or more second hardware processed data streams in a fourth format, while the second sequence of components is processed by the software content security application 730 in the second security processing stage to generate one or more second software processed data streams in a fourth format.

After processed by either the hardware content security application 740 or the software content security application 730, the results from processing the first sequence of components and the second sequence of components are combined by the result aggregation unit 760 in a third security processing stage to generate one or more third processed data streams. The combined result is used to determine whether to allow the email to progress through the system, or to quarantine, delete or clean the email message. In one embodiment one or more processed components are recombined to form a new email message that is sent to the recipient as one or more third processed data streams. In another embodiment one or more components of the email message are quarantined. In yet another embodiment, one or more components of the email message are deleted.

The hardware and software content security applications 720 each contain one or more signature databases which are used to search for malicious content. The signature databases 750 stored in the hardware are compiled into a form amenable to fast matching in hardware, such as those disclosed in U.S. Pat. No. 7,082,044, entitled “Apparatus and Method for Memory Efficient, Programmable, Pattern Matching Finite State Machine Hardware”; U.S. application Ser. No. 10/850978, entitled “Apparatus and Method for Large Hardware Finite State Machine with Embedded Equivalence Classes”; U.S. application Ser. No. 10/850979, entitled “Efficient Representation of State Transition Tables”; U.S. application Ser. No. 10/640870 “Integrated Circuit Apparatus and Method for High Throughput Signature Based Network Applications”; U.S. application Ser. No. 10/927967, entitled “Apparatus and Method for High Performance Data Content Processing”; U.S. application Ser. No. 11/326131 “Fast Pattern Matching Using Large Compressed Databases”; and U.S. application Ser. No. 11/330973, entitled “Apparatus and Method for Processing of Security Capabilities Through In-field Upgrades”, the contents of all of which are incorporated herein by reference in their entirety Likewise, the signature databases stored in software are compiled into a form compatible with fast processing in software. The databases can represent the same or different malicious content.

In one embodiment, the second security processing stage can process signature databases from one or more security vendors. For example, when scanning for viruses, the hardware and software content security applications can use signature databases from the open source Clam project, or commercial vendors like McAfee Corporation, located at 3965 Freedom Circle, Santa Clara, Calif. 95054, USA; Computer Associates Corporation, located at, One CA Plaza, Islandia, N.Y. 11749, USA, Kaspersky Lab, Inc., located at 300 Unicorn Park, Woburn, Mass. 01801, and Sophos Plc, The Pentagon, Abingdon Science Park, Abingdon OX14 3YP, United Kingdom. Users can select one or more signature databases to use when scanning the content. Different databases may have different trade-offs in terms of speed and accuracy when processing in hardware and software, or depending on content. The first security processing stage takes these processing requirements into account when deciding whether to process the data in software or hardware during the second security processing stage 720.

The invention provides for speeding up the aggregate data throughput without compromising security. This is achieved, in part, because the first security processing stage can distribute computational load between the hardware and software based on information extracted from the data itself. The system is able to compensate for messages or message components that are slow to process (for example those with large attachments) by processing more than one message component at a time in hardware and software. Thus, although the latency to process a single email message may not be reduced, the overall system performance is dramatically improved.

Although the foregoing invention has been described in some detail for purposes of clarity and understanding, those skilled in the art will appreciate that various adaptations and modifications of the just-described preferred embodiments can be configured without departing from the scope and spirit of the invention. For example, other pattern matching technologies may be used, or different network topologies may be present. Moreover, the described data flow of this invention may be implemented within separate network systems, or in a single network system, and running either as separate applications or as a single application. The invention is not limited by the logic blocks or integrated circuits configured to perform the above functions. For example, the above operations may be performed using logic hardware disposed in a central processing unit, a graphical processing unit, a multicore processor, or otherwise. Therefore, the described embodiments should not be limited to the details given herein, but should be defined by the following claims and their full scope of equivalents.

What is claimed is:

1. A method for processing information, the method comprising:
receiving a data stream in a first format;
processing the received data stream via a first security processing stage configured to perform a first plurality of tasks at a first processing speed to generate one or more first processed data streams in a second format;
processing the one or more first processed data streams via a second security processing stage configured to perform a second plurality of tasks at a second processing speed to generate one or more second processed data streams in a third format;
said first and second plurality of tasks to include one or more common tasks; and
said first processing speed being greater than said second processing speed.

2. The method of claim 1 wherein said one or more first processed data streams is a first output data stream.

3. The method of claim 1 wherein said one or more second processed data streams is a second output data stream.

4. The method of claim 1 wherein each of said first and second security processing stages is an anti virus processing stage.

5. The method of claim 1 wherein each of said first and second security processing stages is an intrusion detection processing stage.

6. The method of claim 1 wherein each of said first and second security processing stages is an anti spam processing stage.

7. The method of claim 1 wherein each of said first and second security processing stages is an anti spyware processing stage.

8. The method of claim 1 wherein each of said first and second security processing stages is a content processing stage.

9. The method of claim 1 wherein at least one of the first plurality of tasks is performed concurrently with at least one of the second plurality of tasks.

10. The method of claim 1 wherein said first processing stage is further configured to include one or more hardware modules adapted to execute instructions to generate the one or more first processed data streams.

11. The method of claim 1 wherein the one or more first processed data streams are associated with one or more classes of network data each having a different format and each being different from the first format.

12. The method of claim 1 wherein the one or more first processed data streams are associated with one or more classes of network data each having a format different from the first format.

13. The method of claim 1 wherein each of the one or more first processed data streams is directed to a different destination.

14. The method of claim 1 wherein the one or more second processed data streams are associated with one or more classes of network data each having a different format and each being different from the first format.

15. The method of claim 1 wherein the one or more second processed data streams are associated with one or more classes of network data each having a format different from the first format.

16. The method of claim 1 wherein each of the one or more second processed data streams is directed to a different destination.

17. The method of claim 1 wherein the second security processing stage is further configured to generate one or more data streams in a fourth format.

18. The method of claim 23 further comprising:
dividing the received data stream into a first sequence and a second sequence said first sequence being processed by a hardware content security module, and said second sequence being processed by a software content security module.

19. The method of claim 18 further comprising:
combining the one or more second processed data streams having the third format; and
processing the one or more data streams having the fourth format.

20. The method of claim 23 wherein the second security processing stage is configured to process the one or more data streams having the second format data by using one or more content security modules.

21. The method of claim 20 wherein the one or more content security modules are hardware modules.

22. The method of claim 20 wherein the one or more content security modules are commercially available software modules.

23. A processing system comprising:
a first security processing stage configured to perform a first plurality of tasks on a data stream having a first format and at a first processing speed to generate one or more first processed data streams in a second format;
a second security processing stage configured to perform a second plurality of tasks on the one or more first processed data streams at a second processing speed to generate one or more second processed data streams in a third format;
said first and second plurality of tasks to include one or more overlapping tasks; and
said first processing speed being greater than said second processing speed.

24. The processing system of claim 23 wherein said one or more first processed data streams is a first output data stream.

25. The processing system of claim 23 wherein said one or more second processed data streams is a second output data stream.

26. The processing system of claim 23 wherein each of said first and second security processing stages is an anti virus processing stage.

27. The processing system of claim 23 wherein each of said first and second security processing stages is an intrusion detection processing stage.

28. The processing system of claim 23 wherein each of said first and second security processing stages is an anti spam processing stage.

29. The processing system of claim 23 wherein each of said first and second security processing stages is an anti spyware processing stage.

30. The processing system of claim 23 wherein each of said first and second security processing stages is a content processing stage.

31. The processing system of claim 23 wherein said second format is different from said third format.

32. The processing system of claim 23 wherein said first format is different from said second format.

33. The processing system of claim 23 wherein said second format is different from said third format.

34. The processing system of claim 1 wherein said first processing stage is further configured to include one or more hardware modules adapted to execute instructions to generate the one or more first processed data streams.

35. The processing system of claim 23 wherein the one or more first processed data streams are associated with one or more classes of network data.

36. The processing system of claim 23 wherein each of the one or more first processed data streams is directed to a different destination.

37. The processing system of claim 23 wherein the one or more second processed data streams are associated with one or more classes of network data.

38. The processing system of claim 23 wherein each of the one or more second processed data streams is directed to a different destination.

39. The processing system of claim 23 wherein the second security processing stage comprises one or more software content security modules and one or more hardware content security modules, the second security processing stage configured to generate one or more data streams in a fourth format.

40. The processing system of claim 39 wherein the received data stream is divided into a first sequence of components and a second sequence of components, the first sequence of components processed by the hardware content security modules, and the second sequence of components processed by the software content security modules.

41. The processing system of claim 40 further comprising:
a third content security processing stage configured to combine the one or more second processed data streams having the third format, and further configured to process the one or more data streams having the fourth format.

42. The processing system of claim 23 wherein the second security processing stage is configured to process the one or more data streams having the second format data by using one or more content security modules.

43. The processing system of claim 42 wherein the one or more content security modules are hardware modules.

44. The processing system of claim 42 wherein the one or more content security modules are commercially available software modules.
